(19) United States
(12) Patent Application Publication
(10) Pub. No.: US 2022/0309006 A1
(43) Pub. Date: Sep. 29, 2022

(54) INTER-PROCESS COMMUNICATION METHOD AND APPARATUS, COMPUTER DEVICE AND COMPUTER-READABLE MEDIUM

(71) Applicant: Black Sesame Technologies Inc., San Jose, CA (US)

(72) Inventor: Haiying Liu, Chengdu (CN)

(21) Appl. No.: 17/702,419

(22) Filed: Mar. 23, 2022

(30) Foreign Application Priority Data
Mar. 23, 2021 (CN) 202110310010.5

(51) Int. Cl. G06F 12/1009; G06F 9/54

(52) U.S. Cl. CPC G06F 12/1009; G06F 9/544; G06F 2212/651

(57) ABSTRACT

An inter-process communication method and apparatus, a computer device and a computer-readable medium. The method comprising: initializing a calling process and a called process, having respective page tables and virtual memories, and a callback function is defined in the called process; running a thread of the calling process by using the page table of the calling process; executing an instruction of the callback function in the thread of the calling process by switching a page table in use from the page table of the calling process to the page table of the called process, so as to generate a return value of the callback function; and switching the page table in use from the page table of the called process back to the page table of the calling process, and using the page table of the calling process to receive the return value of the callback function.

### CROSS REFERENCE TO RELATED APPLICATION

This patent application claims the benefit and priority of Chinese Patent Application No. 202110310010.5 filed on Mar. 23, 2021, the disclosure of which is incorporated by reference herein in its entirety as part of the present application.

### TECHNICAL FIELD

The present invention relates to the field of operating systems, and in particular to an inter-process communication method and apparatus, a computer device, and a computer-readable medium.

### BACKGROUND

In an operating system, different application programs run in different processes, and when the different application programs need to cooperate with each other, inter-process communication is required. In a micro kernel scenario, as functions, such as driving, originally achieved in a macro kernel are all changed to be achieved by processes, there is frequent inter-process switching.

In existing communication systems, there are multiple ways for inter-process communication, such as message, semaphore, shared memory, etc. These mechanisms are mature, but neither of them can avoid multiple switching between a user mode and a kernel mode, in the micro kernel scenario, there is also frequent inter-process switching. For example, existing inter-process communication mechanisms are generally pipe, message queue, semaphore, socket, or shared memory communication mechanisms, etc. Inter-process communication by these mechanisms requires multiple times of switching between a user mode and a kernel mode and thread/process switching to complete data transfer, and may also be accompanied by data copy. These all bring overheads to communication. For embedded systems and application scenarios with high real-time requirements, the communication efficiency is low, Which cannot meet user requirements.

### SUMMARY

On this basis, regarding the problem of low communication efficiency in existing inter-process communication mechanisms, it is necessary to propose an inter-process communication method and apparatus, a computer device and a computer-readable medium.

One aspect of the present invention provides an inter-process communication method, the method comprising:

initializing a calling process and a called process, wherein the calling process and the called process have respective page tables and virtual memories, and a callback function is defined in the called process;

running a thread of the calling process by using the page table of the calling process;

executing an instruction of the callback function in the thread of the calling process by switching a page table in use from the page table of the calling process to the page table of the called process, so as to generate a return value of the callback function; and

switching the page table in use from the page table of the called process back to the page table of the calling process, and using the page table of the calling process to receive the return value of the callback function.

In one embodiment, initializing a calling process and a called process comprises:

reserving a shared physical memory in a physical memory;

setting a first virtual memory in the virtual memory of the called process, and setting a second virtual memory in the virtual memory of the called process; and

establishing a first mapping between the first virtual memory and the shared physical memory, and establishing a second mapping between the second virtual memory and the shared physical memory;

wherein the first mapping and the second mapping take precedence over mappings between other virtual memories and other physical memories.

In one embodiment, running a thread of the calling process by using the page table of the calling process comprises:

acquiring parameters associated with the callback function, and writing the parameters into a first register;

executing an instruction of the callback function in the thread of the calling process, so as to generate a return value of the callback function comprises:

acquiring the parameters from the first register, and executing the instruction of the callback function on the basis of the parameters, so as to generate a return value of the callback function; and

storing the return value of the callback function in the first register; and

using the page table of the calling process to receive the return value of be callback function comprises reading the return value from the first register.

In one embodiment, running a thread of the calling process by using the page table of the calling process comprises:

writing, through the first mapping, the parameters associated with the callback function to the shared physical memory;

executing an instruction of the callback function in the thread of the calling process, so as to generate a return value of the callback function comprises:

acquiring the parameters from the shared physical memory through the second mapping, and executing the instruction of the callback function on the basis of the parameters, so as to generate a return value of the callback function; and

storing the return value of the callback function in the shared physical memory; and

using the page table of the calling process to receive the return value of the callback function comprises reading the return value from the shared physical memory through the first mapping.

In one embodiment, executing an instruction of the callback function in the thread of the calling process by switching a page table in use from the page table of the calling process to the page table of the called process, so as to generate a return value of the callback function further comprises:

storing, into a memory space, parameters of the page table of the calling process when switching the page table in use, and taking the parameters as page table switching parameters; and

switching the page table in use from the page table of the called process back to the page table of the calling process comprises:

acquiring the page table switching parameters from the memory space, and continuing to run the page table of the calling process on the basis of the page table switching parameters.

In one embodiment, the method further comprises:

when the thread of the calling process is switched out during use of the page table of the called process, storing parameters of the page table of the called process at this time into the memory space, and taking the parameters as page table pausing parameters; and

when the thread of the calling process continues running, continuing to set the page table in use as the page table of the called process, and continuing to ran on the basis of the page table pausing parameters.

In one embodiment, after reading the return value of the callback function, the method further comprises:

canceling the first mapping and the second mapping.

In one embodiment, initializing a calling process and a called process further comprises:

setting switching instructions in the calling process and the called process, wherein the switching instructions are configured to instruct to perform communication between the calling process and the called process.

Another aspect of the present invention provides an inter-process communication apparatus, comprising:

an initialization module, configured to initialize a calling process and a called process, wherein the calling process and the called process have respective page tables and virtual memories, and a callback function is defined in the called process;

a first page table switching module, configured to run a thread of the calling process by using the page table of the calling process; and execute an instruction of the callback function in the thread of the calling process by switching a page table in use from the page table of the calling process to the page table of the called process, so as to generate a return value of the callback function; and

a second page table switching module, configured to switch the page table in use from the page table of the called process back to the page table of the calling process, and use the page table of the calling process to receive the return value of the callback function.

Another aspect of the present invention provides a computer device, comprising a memory and a processor, the memory storing a computer program, wherein the processor executes the computer program to implement the described inter-process communication method.

Another aspect of the present invention provides a computer-readable storage medium, on which a computer program is stored, wherein when executed by a processor, the computer program implements the described inter-process communication method.

According to the described inter-process communication method and apparatus, computer device and computer-readable medium, when running a calling process, by switching a page table in use to a page table of a called process, an instruction of the called process is executed when running a thread of the calling process, so that the instruction of the caned process is executed when running the calling process. Therefore, during inter-process communication, data transfer can be directly completed without switching of processes and threads or data copy. In this way, overheads due to switching of processes and threads are omitted, unnecessary processing procedures of switching between a kernel mode and a user mode are eliminated, and the communication efficiency is increased.

### BRIEF DESCRIPTION OF DRAWINGS

FIG. 1 is a schematic diagram of an existing IPC mechanism;

FIG. 2 is a schematic flowchart of an inter-process communication method according to an embodiment;

FIG. 3 is a summarized schematic diagram of an inter-process communication process according to an embodiment;

FIG. 4 is a schematic diagram of a shared physical memory according to an embodiment;

FIG. 5 is a schematic flowchart of an inter-process communication method according to an embodiment;

FIG. 6 is a schematic flowchart of an inter-process communication method according to an embodiment;

FIG. 7 is a summarized schematic diagram an inter-process communication process according to an embodiment;

FIG. 8 is a summarized schematic diagram of an inter-process communication process according to an embodiment;

FIG. 9 is a block diagram of an inter-process communication apparatus according to an embodiment; and

FIG. 10 is a block diagram of a computer device according to an embodiment.

### DETAILED DESCRIPTION OF THE EMBODIMENTS

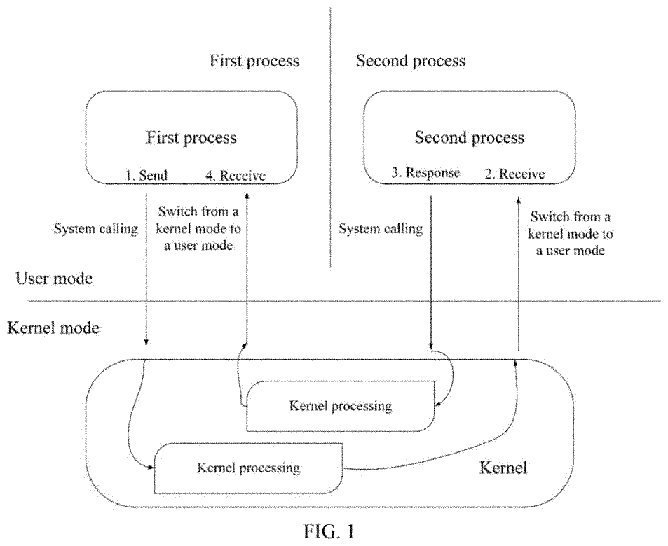

Referring to FIG. 1, in an existing micro kernel system, an IPC (Inter-Process Communication) mechanism is generally used to achieve inter-process communication. For example, in the existing IPC mechanism, when a first process calls an interface of a second process to send data to the second process, the following processes need to be performed: the first process transfers to-be-sent data to a kernel through system calling, requests the kernel to send the data to the second process, and at the same time a cache for storing data is provided in a space of the first process, and thus the first process switches from a user mode to a kernel mode; the kernel sends the request to the second process, and copies the data cached in the space of the first process to a space of the second process; the second process receives the request, receives the data from the kernel and processes the data, and thus the second process switches from a kernel mode to a user mode; the second process generates response data, the response data is transferred to a kernel mode through the system calling, and thus the second process switches from the user mode to the kernel mode; and the first process receives the processed response data from the kernel, and thus the first process switches from the kernel mode to the user mode. Hence, the described process involves system calling and process switching, and one data closed-loop transfer between processes can be completed only after multiple times of switching between a user mode and a kernel mode and switching of processes and threads, and there are overheads of data copy.

In order to reduce the overheads of utter-process communication, the present invention provides an inter-process communication method and apparatus, a computer device and a computer-readable medium, Which are intended to avoid switching of processes and threads during inter-process communication and omit data copy, thereby increasing the communication efficiency.

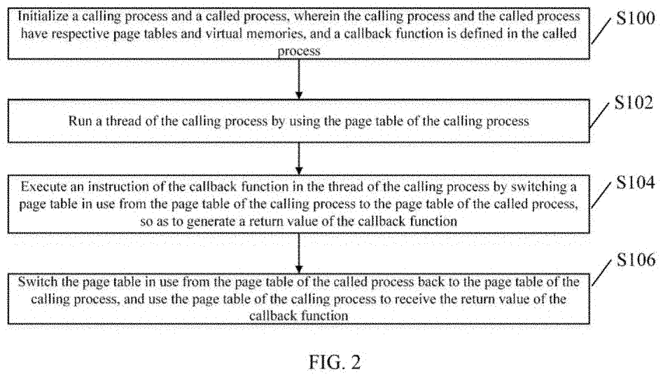

Referring to FIG. 2, the inter-process communication method according, to an embodiment comprises steps S100 to S106.

Step S100: initializing a calling process and a called process, wherein the calling process and the called process have respective page tables and virtual memories, and a callback function is defined in the called process;

step S102: running a thread of die calling process by using the page table of the calling process;

step S104: executing an instruction of the callback function in the thread of the calling process by switching a page table in use from the page table of the calling process to the page table of the called process, so as to generate a return value of the callback function; and

step S106: switching the page table in use from the page table of the called process back to the page table of the calling process, and using the page table of the calling process to receive the return value of the callback function.

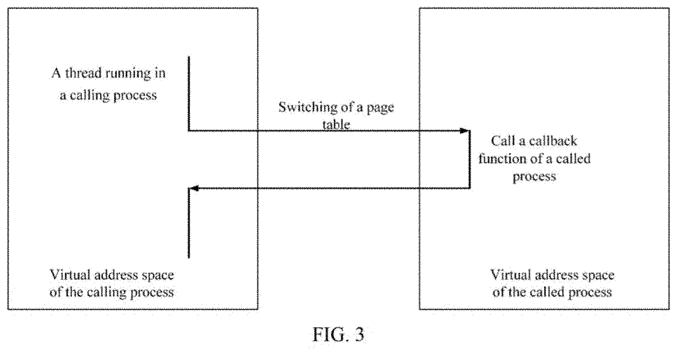

FIG. 3 is a summarized schematic diagram of an inter-process communication process according to an embodiment. As shown in FIG. 3, during executing the thread of the calling process, the page table in use is switched to the page table of a called function, so that a function that calls the called process can be executed in a virtual address space of the called process. The whole communication process is executed in the thread of the calling process, so that when a processor executes inter-process communication, inter-process data transfer can still be achieved through function calling as if in the same process, and thus there is neither switching of processes and threads, nor data copy, thereby increasing the inter-process communication efficiency.

According to the described inter-process communication method, when running a thread of a calling process, by switching a page table in use to a page table of a called process, an instruction of the called process is executed in the thread of the calling process, so that the instruction of the called process is executed when using the calling process. Therefore, during inter-process communication, data transfer can be directly completed without switching of processes and threads or data copy. In this way, overheads due to switching of processes and threads are omitted, unnecessary processing procedures of switching between a kernel mode and a user mode are eliminated, and the communication efficiency is increased.

In some embodiments, in step S100, initializing a calling process and a called process comprises initializing memories, i.e. reserving corresponding virtual memories for the calling process and the called process, and reserving a physical memory for mapping the virtual memories. The virtual memory is a memory space independently allocated to each process by an operating system, the physical memory is a memory based on a hardware structure, and address lines of a processor can directly address the memory space. There are mappings between addresses of the virtual memories and the address of the physical memory, the mappings are stored in page tables, the page tables are used by a Memory Management Unit (MMU), and each process has a corresponding page table.

Specifically, this step further comprises reserving a shared physical memory in a physical memory; setting a first virtual memory in the virtual memory of the called process, and setting a second virtual memory in the virtual memory of the called process; and establishing a first mapping between the first virtual memory and the shared physical memory, and establishing a second mapping between the second virtual memory and the shared physical memory.

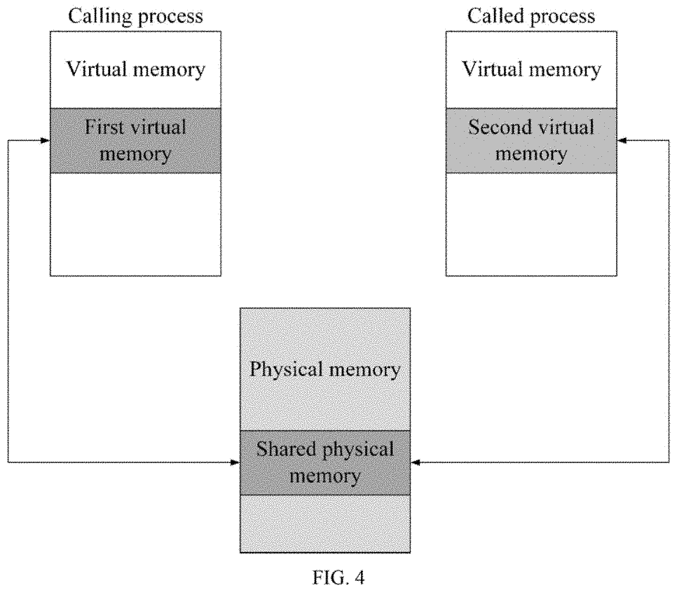

Further, with reference to FIG. 4, a section of fixed virtual address range may be reserved in the virtual memory of the calling process, so as to set the first virtual memory in the virtual memory of the calling process; and by the sane reasoning, a section of fixed virtual address range may be reserved in the virtual memory of the called process, so as to set the second virtual memory in the virtual memory of the called process. Similarly, a section of fixed physical address range may be reserved in the physical memory, so as to reserve the shared physical memory in the physical memory. Preferably, in an seL4 micro kernel scenario of a Linux system, when a memory is initialized, a field for managing the memory may be reserved, for example, adding functions such as capability control to the memory. The shared physical memory is provided by a specific interface, can be simultaneously accessed by multiple processes, is actually a memory space in a physical sense, but is simultaneously mapped to spaces of virtual addresses of multiple processes.

By using the shared physical memory, both the calling process and the called process can access the shared physical memory, and thus data can be directly transferred through the shared memory, and data copy is not needed in the communication process.

The first virtual memory, the second virtual memory, and the shared physical memory are managed in a unified manner, mapping between the first virtual memory or the second virtual memory and the shared physical memory and mappings between other virtual memories and other physical memories coexist in a page table, and memory access is achieved by MMU switching.

Preferably, the first mapping and the second mapping take precedence over mappings between other virtual memories and other physical memories Therefore, when mappings between other virtual memories and other physical memories in the processes are allocated, the mapping between the first virtual memory or the second virtual memory and the shared physical memory will not be covered, thereby ensuring the space for inter-process data transfer.

It can be understood that the first mapping is used to establish a correlation between a virtual address of the first virtual memory and a physical address of the shared physical memory, and the second mapping is used to establish a correlation between a virtual address of the second virtual memory and the physical address of the shared physical memory. Therefore, further preferably, the correlation between the virtual address of the first virtual memory and the physical address of the shared physical memory is the same as the correlation between the virtual address of the second virtual memory and the physical address of the shared physical memory, that is, the same physical address corresponds to the same virtual addresses of the first virtual memory and the second virtual memory.

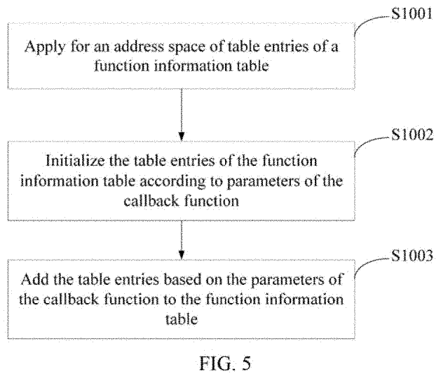

In some embodiments, information associated with the callback function is stored in a function information table. The callback function information table is managed by an operating system, that is, the operating system manages functions, which can be called, of a process. Therefore, referring to FIG. 5, defining a callback function in the called process comprises:

S1001: applying for an address space of table entries of a function information table;

S1002: initializing the table entries of the function information table according to parameters of the callback function; and

S1003: adding the table entries based on the parameters of the callback function to the function information table.

Initializing the table entries of the function information table according to parameters of the callback function comprises defining parameter structures of the callback function, defining of virtual memory pointers, and registering an interface of the callback function.

For example, the parameter structures of the callback function include: a valid flag, the number of parallel calls, a KEYED (an identifier ID of the callback function the address of a page table of a process to which the callback function belongs, the address of a dedicated stack, and the address of the callback function.

Defining virtual memory pointers specifically comprises defining a first virtual memory pointer and a second virtual memory pointer. The first virtual memory pointer may be used for an input parameter and an output parameter. When data transferred by the memory needs to be used by the called process for a long time, the first virtual memory pointer can be reserved in the called process. In cases where the first virtual memory pointer is reserved in the called process, the second virtual memory pointer may also be defined, and the second virtual memory pointer is used for an output parameter; otherwise, the second virtual memory pointer may be NULL.

Parameters of the interface of the callback function may include: an identifier of the called process, a callback function pointer registered by the called process, the number of parallel calls allowed by the callback function (defining the number of parallel calls to limit malicious calls), distinguishing identifiers for distinguishing multiple callback functions in the called process, and transfer memories such as a stack space and a return value used by the called process when executing the callback function.

In some embodiments, initializing a calling process and a called process further comprises, in the calling process, applying for calling the callback function of the called process.

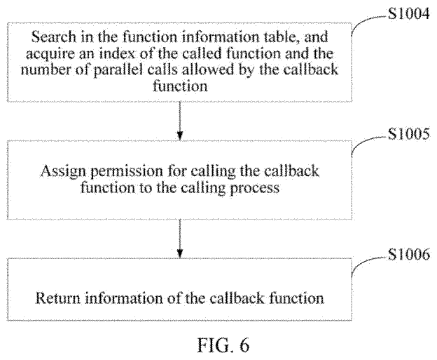

Referring to FIG. 6, in the calling process, applying for accessing the callback function of the called process comprises:

S1004: searching in the function information table, and acquiring an index of the callback function and the number of parallel calls allowed by the callback function;

S1005: assigning permission for calling the callback function to the calling process; and

S1006: returning information of the callback function.

By means of the described steps, the function of the called process is applied for use in the calling process, and applying for calling the calling process is achieved by searching in the function information table so as to acquire the index of the callback function.

In some embodiments, preferably, initializing a calling process and a called process further comprises setting switching instructions in the calling process and the called process, wherein the switching instructions are configured to instruct to perform communication between the calling process and the called process.

During the described inter-process communication, it is required to enter a kernel mode to perform operations such as switching a page table and modifying a stack pointer. However, when switching from a user mode to a kernel mode, in order to consider generality, an execution path is relatively long, and also comprising many resources that need to be stored and restored, and therefore a conventional switching path consumes a large amount of instructions. In order to achieve efficient communication between the calling process and the called process, switching instructions are set in the calling process and the called process for instructing communication between the calling process and the called process. By means of the instructions, a processor can quickly recognize an inter-process communication request, and execute fast switching between a user mode and a kernel mode, without a general switching flow, thereby reducing consumption of instructions, and achieving fast switching between the user mode and the kernel mode.

Taking an ARM processor as an example, immediate parameters of svc instructions may be set as the switching instructions, for example, svc #1 is configured to request switching from the calling process to the called process, and svc #2 is configured to request switching from the called process back to the calling process. For other functions, other immediate parameters of svc are used.

How to achieve data transfer between processes is a key to achieve inter-process communication. Hereinafter, a data transfer process between the calling process and the called process according to the present invention will be described in detail.

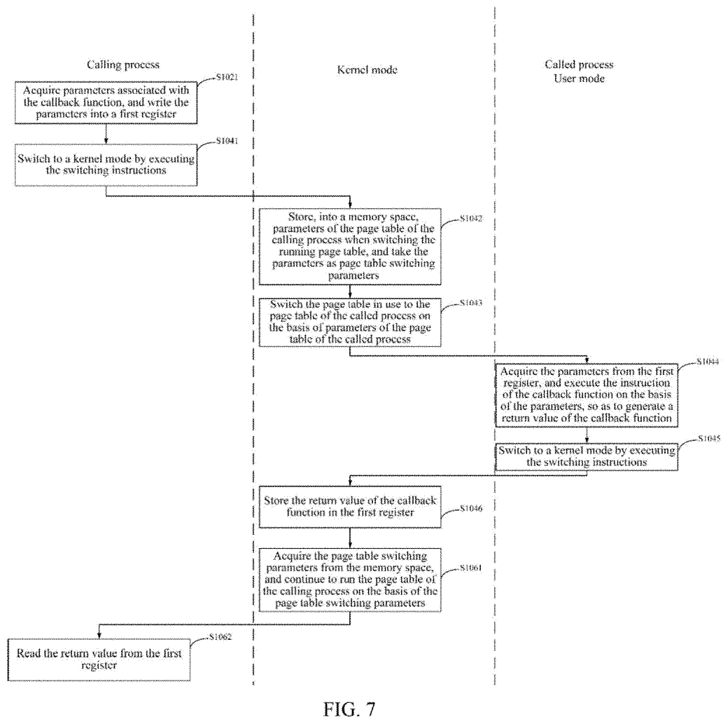

In some embodiments, referring to FIG. 7, data transfer between the calling, process and the called process is achieved by using a register.

In this embodiment, in step S102, running a thread of the calling process by using the page table of the calling process comprises step S1021: acquiring parameters associated with the callback function, and writing the parameters into a first register;

wherein the calling process can acquire parameters associated with the callback function by searching in the function information table and on the basis of the index of the callback function. The parameters associated with the callback function may include: a stack address of the callback function, the address of a page table of a process (the called process) to which the callback function belongs, the address of the function, etc. In addition, the parameters associated with the callback function further include an argument of the callback function, that is, a parameter which is defined by the calling process and on which an operation needs to be performed by the callback function. Then, the described parameters are stored in the first register. The first register may be a general purpose register in a computer device, and configured to transfer and temporarily store data. Taking a 64-bit general purpose register as an example, an input parameter can transfer eight pieces of 8-byte data, and can return up to eight pieces of 8-byte data as a return value, which can satisfy most communication scenarios and is particularly suitable for managing communication of data.

It should be understood that the first register may comprise multiple general purpose registers, and may be, for example, a set of general purpose registers. In addition, in different CPU architectures, the first register has different dedicated names, as long as it is a register capable of implementing the described functions.

In step S104, executing an instruction of the callback function in the thread of the calling process by switching a page table in use from the page table of the calling process to the page table of the called process, so as to generate a return value of the callback function may specifically comprise the following steps S1041 to S1046:

step S1041: switching to a kernel mode by executing the switching instructions. According to the svc #1 instruction set in the calling process, the page table in use is switched from the page table of the calling process to the page table of the called process. According to the analysis above, by executing the svc #1 instruction, the processor can quickly identify and execute processing of page table switching.

Step S1042: storing, into a memory space, parameters of the page table of the calling process when switching the page table in use, and taking the parameters as page table switching parameters. When the page table in use is switched, the parameters of the page table of the calling process at this time are stored in the memory space as page table switching parameters, and parameters of the page table of the calling process are backed up, so that when the page table in use is switched back to the page table of the calling process again, the calling process continues to run on the basis of the page table switching parameters. The described memory space for storing the page table switching parameters is a memory area exclusively belonging to the calling process in the physical memory of a computer. Taking the ARM processor as an example, for example, the page table switching parameters include related data of the calling process, such as a processor page table address register (ttbr, for switching a page table), a stack top pointer register tsp, stack top pointer), a subroutine return address register (lr, for finding, when the callback function is called, a next instruction after calling the function by using the address), and a frame pointer register (fp, stack bottom pointer), By storing the described page table switching parameters in the memory space, page table information when the page table is witched can be stored, so that when the page table in use is switched back to the page table of the calling process again the calling process can continue to run on the basis of a running position when the page table of the calling process is switched, and thus the instructions of the calling process can be executed sequentially and accurately.

Step S1043: switching the page table in use to the page table of the called process on the basis of parameters of the page table of the called process. Similarly, for example, the parameters of the page table of the called process include related data of the called process, such as a processor page table address register (ttbr, for switching a page table), a stack top pointer register (sp, stack top pointer), and a frame pointer register (fp).

Through the step S1043, the page table in use is switched from the page table of the calling process to the page table of the called process, Specifically, the instruction of the callback function is executed in the thread of the calling process, but the callback function defined in the called process cannot access a stack corresponding to the thread of the calling process, and the callback function does not belong to any thread of the called process, that is, an actual running thread of the callback function at this time is not in any thread of the called process, and therefore, at this time, a callback function dedicated stack needs to be created for the callback function, for use when the callback function is called and executed. A stack space required by the callback function dedicated stack is reserved when registering an interface of the callback function, and is located in the memory of the called process. Further, if parallel execution of N callback functions are supported, N callback function dedicated stacks are created, wherein the callback function dedicated stacks correspond to the callback functions on a one-to-one basis. In step S1043, when the page table in use is switched to the page table of the called process, parameters related to the stack pointer are switched to the newly created callback function dedicated stack.

Step S1044: acquiring the parameters from the first register, and executing the instruction of the callback function on the basis of the parameters, so as to generate a return value of the callback function.

In step S1044, on the basis of the switched stack pointer (sp), the callback function is executed by using the callback function dedicated stack.

Step S1045: switching to a kernel mode by executing the switching instructions.

Step S1046: storing the return value of the callback function in the first register.

In other words, in the process of the described steps S1041 to S1046, the parameters that need to be communicated between the calling process and the called process are transferred via the first register, so as to execute the callback function in the called process during the execution of the calling process.

In step S106, switching the page table in use from the page table of the called process back to the page table of the calling process, and using the page table of the calling process to receive the return value of the callback function may comprise the following steps S1061 and S1062:

step S1061: acquiring the page table switching parameters from the memory space, and continuing to run the page table of the calling process on the basis of the page table switching parameters.

It should be understood that in step S1061, the page table in use is switched back to the page table of the calling process, and parameters related to the stack pointer are switched back to a stack corresponding to the thread of the calling process, and thus a thread stack is switched back to the stack corresponding to the thread of the calling process.

Step S1062: reading the return value from the first register. The return value may be used subsequently by the calling process.

It can be determined from the steps above that the callback function defined in the called process is called by switching the page table in use, so as to obtain the return value of the callback function. In some embodiments, in the described process, before acquiring the parameters associated with the callback function from the first register, a calling return address of the callback function is further stored in a second register, so that after the callback function is executed, an instruction of the called process can continue to be executed on the basis of the calling return address. In addition, when the return value of the callback function is of a conventional data type (for example, an integer type or a pointer type), after the return value of the callback function is generated, the return value is stored in the second register. Taking the ARM processor as an example, the second register may be an X0 register for transferring the return value and parameters during calling of a subroutine, and then the return value is acquired from the second register and stored in the first register.

Alternatively, when the return value of the callback function has a large data structure (e.g., a customized data structure), the return value of the callback function is stored in an address space pointed to by an indirect result register. The value in the indirect result register is a memory address, and a memory pointed to by the memory address is used to store the return value of the callback function. A section of address is reserved in the memory of the called process, and the memory space pointed to by the reserved section of address is used to store the return value of the callback function. In this case, after the page table in use is switched to the page table of the called process, firstly, the indirect result register is stored in the memory of the called process, that is, an original value of the indirect result register is backed up, and the reserved address is simultaneously stored in the indirect result register (for storing the return value of the callback function); and after executing the callback function and generating the return value of the callback function, the return value is stored into the memory pointed to by the reserved address of the called process. After the called process switches from a user mode to a kernel mode, then the return value is stored in the first register. The return value is finally returned to the user mode of the calling process through the first register. After the execution of the callback function is completed, the backup original value of the indirect result register is restored to the indirect result register so that the indirect result register restores the original value. In the ARM processor, the indirect result register may be an X8 register.

In one embodiment, a memory for backing up the X8 register, a memory storing a return value of a function, and the stack space of the callback function specific stack are a section of dedicated continuous address space in the memory of the called process, and used for stack and data transfer memory.

In the described processing, the memory of the calling process is a virtual memory of the calling process that is different from the first virtual memory, and the memory of the called process is a virtual memory of the called process that is different from the second virtual memory.

By means of the described processing, when the calling process is executed, by switching the page table in use to the page table of the called process, an instruction of the called process is executed when a thread of the calling process is run. In this process, an execution thread of the thread is not subjected to switching of system scheduling, and overheads caused by switching of threads or processes will not be generated due to inter-process communication.

In the described embodiments in which data transfer between a calling process and a called process is implemented by using a first register, it is suitable to transfer parameters of limited size. For example, when the first register is a 64-bit register, it is suitable to transfer eight 8-byte parameters. By transferring parameters through the first register, synchronous communication can be achieved.

As another example of transferring, data between processes, in some embodiments, when the amount of data to be transferred between a calling process and a called process is large, the transfer of large amounts of data between the calling process and the called process is achieved by using a shared physical memory. In this embodiment, the process of inter-process communication is similar to the process of performing inter-process data transfer by using a register as shown in FIG. 7, and the difference lies in that the first register is replaced with a shared physical memory. Therefore, hereinafter, only portions different from the described embodiments will be described.

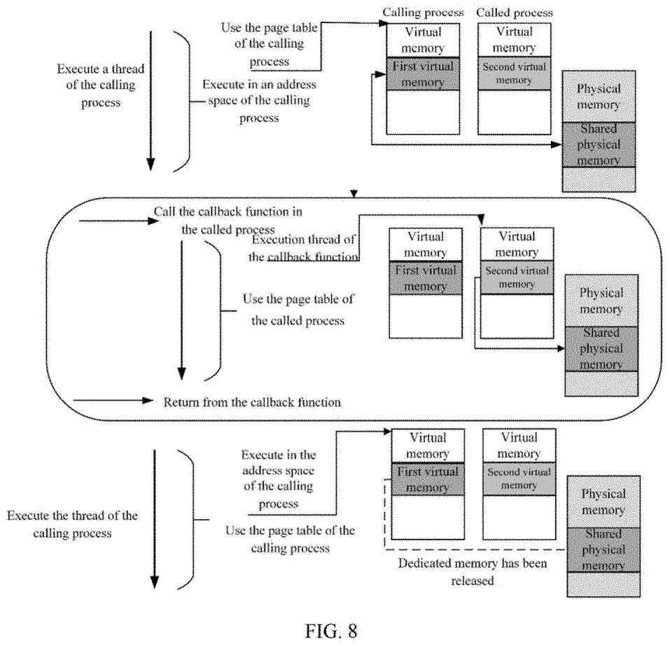

With further reference to FIGS. 4 and 8, in some embodiments, in the initialization phase, the shared physical memory is reserved in the physical memory, so that both the calling process and the called process can access the shared physical memory.

In some embodiments, in step S102, running a thread of the calling process by using the page table of the calling process comprises writing, through the first mapping, the parameters associated with the callback function to the shared physical memory.

In step S104, executing an instruction of the callback function in the thread of the calling process, so as to generate a return value of the callback function comprises acquiring the parameters from the shared physical memory through the second mapping, and executing the instruction of the callback function on the basis of the parameters, so as to generate a return value of the callback function: and storing the return value of the callback function in the shared physical memory.

In step S106, using the page table of the calling process to receive the return value of the callback function comprises reading the return value from the shared physical memory through the first mapping.

The shared physical memory is a section of physical memory that can be accessed by both the calling process and the called process, it can be determined from the described steps that data of the shared physical memory is acquired and transferred through mapping, so as to achieve data transfer between the calling process and the called process. As such, no data copy is needed. In addition, data transfer between processes is achieved by a shared physical memory, and larger memory data can be transferred, as long as the space of the physical shared memory applied for is larger than the size of data to be transferred. Thus, embodiments in which data transfer is achieved by a shared physical memory are suitable for transferring network packets, file caches, etc. between processes. By means of the shared physical memory, memory data can be transferred to the called process; after acquiring the memory data, other processes can return to this calling first, and place the memory data in a cache queue; and after the processing of the memory data is completed, the calling process is then notified, thereby achieving asynchronous communication. Alternatively, the data can also be processed directly in the callback function and returned, thereby achieving synchronous communication.

After parameter transfer is completed, that is, after the return value of the callback function is generated, the first mapping and the second mapping: can be canceled, so that the calling process and the called process can no longer acquire data from the shared physical memory, thereby ensuring data security in the shared physical memory.

In this embodiment, the manner of switching the page table in use is the same as that in the described embodiments, and will not be repeated herein. It should be understood that a register and a shared physical memory can be used in combination to transfer parameters, so as to adapt to diversified parameter transfer requirements.

In some embodiments, when the thread of the calling process is switched out by scheduling of an operating system during use of the page table of the called process, storing parameters of the page table of the called process at this time into the memory space, and taking the parameters as page table pausing parameters; and when the thread of the calling process continues running, continuing to set the page table in use as the page table of the called process, and continuing to run the calling process on the basis of the page table pausing parameters.

The thread of the calling process may be switched out during running and is in a sleep state. If the callback function is still not completed when the process is switched out, when the thread stops sleeping and is re-running, on the basis of stored parameters of the page table when the thread is switched out, the page table in use continues to be set as the page table of the called process, so as to ensure that the callback function can continue to be executed after being paused. In some embodiments, the page table pausing parameters can be stored in a thread data block, for accessing by a scheduler of an operating system, in addition, when the page table in use is switched to the page table of the called process, the page table pausing parameters should be stored in the thread data block immediately. After the execution of the callback function is completed, when the page table in use is switched back to the page table of the calling process, a temporal), page table in the thread data block should be restored to the page table of the calling process.

In the described embodiments, the communication process between the calling process and the called process is described. However, the present invention is not limited to communication between two processes. Specifically, the called process can further call a second-level called process, and the second-level called process can further call a third-level called process, and so on. After the third-level called process is returned, the second-level called process continues to be executed; after the second-level called process is returned, the called process continues to be executed; and after the called process is returned, the calling process continues to be executed, and so on. In this case, page table switching parameters of a process of a previous level need to be stored in sequence in a stack manner, that is, page table switching parameters of the calling process, the called process, the second-level called process, and the third-level called process are stored and pushed in sequence, and when returning, the page table switching parameters of the third-level called process, the second-level called process, the called process, and the calling process are popped in sequence, so as to restore page table data of a process of a previous level layer by laver, and ensure that after returning, an address space of a caller is correctly switched back.

A summarized schematic diagram of an inter-process communication process according to an embodiment of the present invention is as shown in FIG. 8. The process of the inter-process communication method according to the present invention is always executed in the thread of the calling process. The method is performed in the virtual address space of the calling process before switching the page table in use; and after switching the page table in use, as the page table in use is switched to the page table of the called process, the method is performed in the virtual address space of the called process. Therefore, the inter-process communication is achieved only by switching the page table in use.

The described method according to embodiments may be executed by a processor, such as an ARM processor, to implement inter-process communication. The described method may be applied to a Linux operating system, and more specifically, applied to an seL4 micro kernel system. However, it should be understood that a person skilled in the art could apply the method of the present invention to other processors and other operating systems when making appropriate modifications and variations.

According to the inter-process communication method of the present invention, the overheads of switching of a kernel mode are reduced, the overheads of inter-process switching are reduced, and the overheads of data copy are reduced, thereby simplifying the communication process, and greatly increasing the communication efficiency. This is particularly useful for systems which have high requirements on communication real-timeliness, for example, autonomous driving vehicle-mounted systems. For example, for an seL4 micro kernel, the running speed using the inter-process communication method according to the present invention is 3 to 3.8 times that of the existing communication methods. In addition, the present invention does not require special hardware modification and large-scale modification of a, kernel, and is an efficient inter-process communication method which is easily implemented.

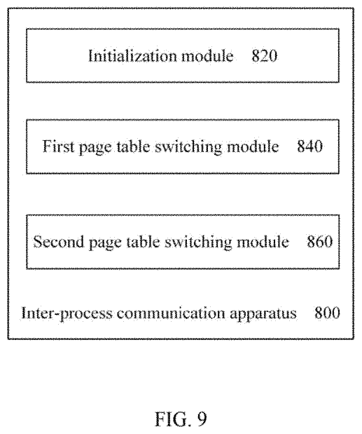

Referring to FIG. 9, in one embodiment, an inter-process communication apparatus 800 is provided, and comprises an initialization module 820, a first page table switching module 840 and a second page table switching module 860. The initialization module 820 is configured to initialize a calling process and a called process, wherein the calling process and the called process have respective page tables and virtual memories, and a callback function is defined in the called process; the first page table switching module 840 is configured to run a thread of the calling process by using a page table of the calling process; and execute an instruction of the callback function in the thread of the calling process by switching a page table in use from the page table of the calling process to a page table of the called process, so as to generate a return value of the callback function; and the second page table switching module 860 is configured to switch the page table in use from the page table of the called process back to the page table of the calling process, and use the page table of the calling process to receive the return value of the callback function.

According to the described inter-process communication apparatus, when running a thread of a calling process, by switching a page table in use to a page table of a called process, an instruction of the called process is executed in the thread of the calling process, so that the instruction of the called process is executed when using the calling process. Therefore, during inter-process communication, data transfer can be directly completed without switching of processes and threads or data copy. In this way, overheads due to switching of processes and threads are omitted, unnecessary processing procedures of switching between a kernel mode and a user mode are eliminated, and the communication efficiency is increased.

In some embodiments, the initialization module 820 is further configured to: reserve a shared physical memory in a physical memory; set a first virtual memory in the virtual memory of the called process, and set a second virtual memory in the virtual memory of the called process; and establish a first mapping between the first virtual memory and the shared physical memory, and establish a second mapping between the second virtual memory and the shared physical memory; wherein the first mapping and the second mapping take precedence over mappings between other virtual memories and other physical memories.

In some embodiments, the first page table switching module 840 is further configured to: acquire parameters associated with the callback function, and store the parameters into a first register; acquire the parameters from the first register, and execute the instruction of the callback function on the basis of the parameters, so as to generate a return value of the callback function; and store the return value of the callback function in the first register; and the second page table switching module 860 is further configured to: use the page table of the calling process to receive the return value of the callback function, which comprises: reading the return value from the first register.

In some embodiments, the first page table switching module 840 is further configured to: write, through the first mapping, parameters associated with the callback function to the shared physical memory; acquire the parameters from the shared physical memory through the second mapping, and execute the instruction of the callback function on the basis of the parameters, so as to generate a return value of the callback function; and store the return value of the callback function in the shared physical memory; and the second page table switching module 860 is further configured to: read the return value from the shared physical memory through the first mapping.

In some embodiments, the first page table switching module 840 is further configured to: store, into a memory space, data of the page table of the calling process when switching the page table in use, and take the parameters as page table switching parameters; and the second page table switching module 860 is further configured to: acquire the page table switching parameters from the memory space, and continue to run the page table of the calling process on the basis of the page table switching parameters.

In some embodiments, the first page table switching module 840 is further configured to: when the thread of the calling process is switched out during, use of the page table of the called process, store parameters of the page table of the called process at this time into the memory space, and take the parameters as page table pausing parameters; and the second page table switching module 860 is further configured to: when the calling thread continues using, continue to set the page table in use as the page table of the called process, and continue to use on the basis of the page table pausing parameters.

In some embodiments, the second page table switching module 860 is further configured to: cancel the first mapping and the second mapping.

In some embodiments, the initialization module 820 is further configured to: set switching instructions in the calling process and the called process, Wherein the switching instructions are configured to instruct to perform communication between the calling process and the called process.

The inter-process communication apparatus according to the embodiment can implement processing similar to the described inter-process communication method, and reference can be made to the described inter-process communication method for the specific implementation process thereof, which will not be repeated herein.

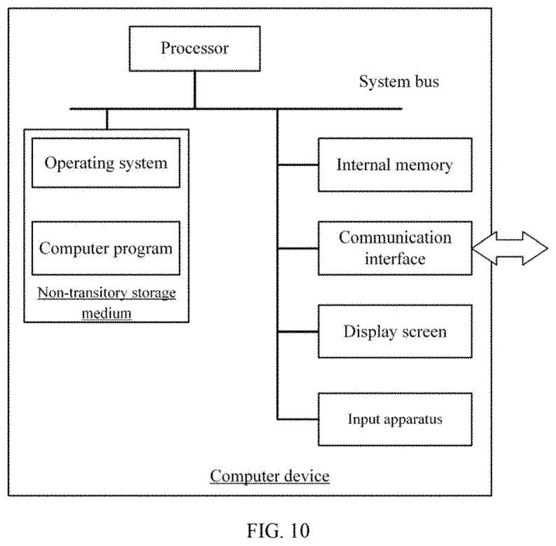

In one embodiment, a computer device is provided. The computer device may be a terminal, and the internal structure diagram of the computer device can be as shown in FIG. 10. The computer device comprises a processor, a memory, a network interface, a display screen, and an input apparatus which are connected through a system bus. The processor of the computer device is configured to provide computing and control capabilities. The memory of the computer device comprises a non-transitory storage medium and an internal memory. The non-transitory storage medium stores an operating system and a computer program. The internal memory provides an environment for running of the operating system and the computer program in the non-transitory storage medium. The network interface of the computer device is configured to communicate with an external terminal through network connection. The computer program is executed by the processor to implement the steps in the described method embodiments. The display screen of the computer device may be a liquid crystal display screen or an electronic ink display screen. The input apparatus of the computer device may be a touch layer covered on the display screen, may also be a key, a trackball or a touch panel arranged on a housing of the computer device, and may also be an external keyboard, touch panel or mouse, etc.

A person skilled in the art could understand that the structure shown in FIG. 10 is only a block diagram of some structures related to the solution of the present application, and does not limit the computer device to Which the solution of the present application is applied. A specific, computer device may comprise more or fewer components than those shown in the figure, or be combined with some components, or have different component arrangements.

The present invention further provides a non-transitory computer-readable storage medium storing one or more computer-readable instructions, and the computer-readable instructions, when executed by one or more processors, enable one or more processors to execute the steps in the described method embodiments.

In a preferred embodiment, the described instructions may be loaded in the same address section of the virtual memories of the calling process and the called process, for example, the described instructions are loaded in a space with an address 1000 to 8000 of the virtual memory of the calling process, and are simultaneously loaded in a space with an address 1000 to 8000 of the virtual memory of the called process. In this case, the current instructions can be correctly acquired when a CPU sequentially loads the instructions before and after switching the page table, thereby achieving smooth switching of page table space without affecting the execution of the thread of the calling process. However, the described instructions may also be loaded in different address sections of the virtual memories of the calling process and the called process, as long as corresponding addressing and lump instructions are added to correctly acquire instructions to be executed.

A person of ordinary skill in the art would understand that all or some processes of the methods in the described embodiments may be completed by computer-readable instructions instructing relevant hardware. The computer-readable instructions may be stored in a non-transitory computer-readable storage medium. When the computer-readable instructions are executed, the processes of the described method embodiments can be comprised. Any references to memory, storage, database, or other media used in the embodiments provided in the present application may comprise non-transitory and/or transitory memory. The non-transitory memory may include read only memory (ROM), programmable ROM (PROM), electrically programmable ROM (EPROM), electrically erasable programmable ROM (EEPROM), or flash memory. The transitory memory may include random access memory (RAM) or external cache memory. By way of illustration but not limitation, RAM can be obtained in multiple forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus (Rambus) direct RAM (RDRAM), direct memory bus dynamic RAM (DRDRAM), and memory bus dynamic RAM (RDRAM), etc.

Various technical features of the described embodiments can be combined in any way, and in order to make the description brief, not all possible combinations of the technical features of the described embodiments are described. However, as long as combinations of these technical features are not contradictory, they shall be considered to belong to the scope disclosed in the description.

The described embodiments merely represent several embodiments of the present invention, and the description thereof is specific and detailed, but the specific and detailed description cannot be understood as limiting the patent scope of the present invention. It should be noted that for a person of ordinary skill in the art, several modifications and improvements can be made without departing from the concept of the present invention, and all these modifications and improvements belong to the scope of protection of the present invention. Therefore, the scope of protection of the present patent application shall be subject to the appended claims.

What is claimed is:

1. An inter-process communication method comprising:
initializing a calling process and a called process, wherein the calling process and the called process have respective page tables and virtual memories, and a callback function is defined in the called process;
running a thread of the calling process b using the page table of the calling process;
executing an instruction of the callback function in the thread of the calling process by switching a page table in use from the page table of the calling process to the page table of the called process, so as to generate a return value of the callback function; and
switching the page table in use from the page table of the called process back to the page table of the calling process, and using the page table of the calling process to receive the return value of the callback function.

2. The method according to claim 1, wherein initializing a calling process and a called process comprises:
reserving a shared physical memory in a physical memory;
setting a first virtual memory in the virtual memory of the called process, and setting a second virtual memory in the virtual memory of the called process; and
establishing a first mapping between the first virtual memory and the shared physical memory, and establishing a second mapping between the second virtual memory and the shared physical memory;
wherein the first mapping and the second mapping take precedence over mappings between other virtual memories and other physical memories.

3. The method according to claim 1, wherein executing an instruction of the callback function in the thread of the calling process by switching a page table in use from the page table of the calling process to the page table of the called process, so as to generate a return value of the callback function comprises:
creating a callback function dedicated stack for the callback function, and switching parameters related to a stack pointer to the newly created callback function dedicated stack.

4. The method according to claim 1, wherein
running a thread of the calling process by using the page table of the calling process comprises:
acquiring parameters associated with the callback function, and writing the parameters into a first register;
executing an instruction of the callback function in the thread of the calling process, so as to generate a return value of the callback function comprises:
acquiring the parameters from the first register; and executing the instruction of the callback function on the basis of the parameters, so as to generate a return value of the callback function; and
storing the return value of the callback function in the first register; and
using the page table of the calling process to receive the return value of the callback function comprises reading the return value from the first register.

5. The method according to claim 2, wherein
running a thread of the calling process by using the page table of the calling process comprises:
writing, through the first mapping, the parameters associated with the callback function to the shared physical memory;
executing an instruction of the callback function in the thread of the calling process, so as to generate a return value of the callback function comprises:
acquiring the parameters from the shared physical memory through the second mapping, and executing the instruction of the callback function on the basis of the parameters, so as to generate a return value of the callback function; and
storing the return value of the callback function in the shared physical memory; and
using the page table of the calling process to receive the return value of the callback function comprises reading the return value from the shared physical memory through the first mapping.

6. The method according to claim 5, wherein
executing an instruction of the callback function in the thread of the calling process by switching a page table in use from the page table of the calling process to the page table of the called process, so as to generate a return value of the callback function further comprises:
storing, into a memory space, parameters of the page table of the calling process when switching the page table in use, and taking the parameters as page table switching parameters; and
switching the page table in use from the page table of the called process back to the page table of the calling process comprises:
acquiring the page table switching parameters from the memory space, and continuing to run the page table of the calling process on the basis of the page table switching parameters.

7. The method according to claim 6, Wherein the method further comprises:
when the thread of the calling process is switched out during use of the page table of the called process, storing parameters of the page table of the called process at this time into the memory space, and taking the parameters as page table pausing parameters; and
when the thread of the calling process continues running, continuing to set the page table in use as the page table of the called process, and continuing to run on the basis of the page table pausing parameters.

8. The method according to claim 5, wherein after reading the return value of the callback function, the method further comprises:
canceling the first mapping and the second mapping.

9. The method according to claim 1, wherein initializing a calling process and a called process further comprises:
setting switching instructions in the calling process and the called process, wherein the switching instructions are configured to instruct to perform communication between the calling process and the called process.

10. An inter-process communication apparatus, wherein the inter-process communication apparatus comprises:
an initialization module, configured to initialize a calling process and a called process, wherein the calling process and the called process have respective page tables and virtual memories, and a callback function is defined in the called process;
a first page table switching module, configured to run a thread of the calling process by using the page table of the calling process; and execute an instruction of the callback function in the thread of the calling process by switching a page table in use from the page table of the calling process to the page table of the called process, so as to generate a return value of the callback function; and
a second page table switching module, configured to switch the page table in use from the page table of the called process back to the page table of the calling process, and use the page table of the calling process to receive the return value of the callback function.

11. A computer device, comprising a memory and a processor, the memory storing a computer program, wherein when executing the computer program, the processor implements the method according to claim 1.

12. A computer-readable storage medium, on which a computer program is stored, wherein when executed by a processor, the computer program implements the method according to claim 1.
